(19) United States
(12) Patent Application Publication
(10) Pub. No.: US 2002/0089974 A1
(43) Pub. Date: Jul. 11, 2002

(54) Data transport system and process

(76) Inventor: Claudia Barucke Marcondes Paes Leme, Rio de Janeiro (BR)

Correspondence Address: SMITH, GAMBRELL & RUSSELL, LLP, Suite 800, 1850 M STREET, N.W., WASHINGTON, DC, 20036, US

(21) Appl. No.: 09/984,629

(22) Filed: Oct. 30, 2001

(30) Foreign Application Priority Data
Jan. 9, 2001 (BR) PI0100036-5

(51) Int. Cl. H04L 12/28; H04L 12/56

(52) U.S. Cl. 370/352; 370/389; 370/401

(57) ABSTRACT

This invention refers to a data transmission system and process wherein a data packet (1) to be transmitted in a telecommunications network with a tag (2) containing destination and origin information (2.1, 2.2) of said packet (1). In each node of a packet path (1), tag (2) will be read and there will be no need to open the former. Information contained in tag (2) is constituted of a constellation of RF subcarriers (2) and its detection is accomplished by checking for absence or presence of subcarriers. The process is accomplished without needing to modulate subcarriers, whereby the checking of the information contained is accelerated.

### FIELD OF INVENTION

This invention entails a data transport system in a telecommunication network, using radio frequency subcarriers.

### DESCRIPTION OF THE STATE OF THE ART

Since the early 90's, a large growth in telecommunication services has been experienced due to an intense and increasing use of Internet Protocol (IP)-based networks. Starting from dedicated and specific applications in the 70's, restricted to the scientific community, 64 kbps connections have become widely used on account of access availability, transport and a large number of microcomputer users. This stage, which can be considered the “first Internet wave”, had such an intense expansion that, in the mid-90's, data transport networks in the United States began to present occupation rates incompatible with the Quality of Service (QoS) required by American Internet server subscribers, due to line busy signals and long delays in Internet applications.

Multiplex technology by wavelength division (WDM) has proved to be extremely effective and of very fast installation, dispensing with operations in the infrastructure of fiber optics already installed. The improved operation of data transport networks has been reflected immediately in Internet applications, allowing the immediate acceptance of new subscribers.

By means of the subscriber incorporation of a second and a third home telephone line installation of WDM systems has begun in metropolitan optical networks. The number of optical carriers, which was initially limited to four units, has reached values of eight, sixteen, thirty-two and sixty-four units. Internet providers then started to offer multimedia services, e-commerce, e-business, web games, among others, by means of an Integrated Services Digital Network (RDSI-ISDN) and, more recently, ADSL (Asymmetrical Digital Subscriber Line).

Another trend identified was the voice services transport over IP (Voice over IP—VoIP) by the Internet services providers (ISP), as an alternative to traditional telephone services. IP Providers based themselves on the high reliability of the optical means and abandoned the stringent telephone hierarchies and the protection and restoration schemes used till then. In this way, IP applications on DWDM (Dense Wavelength Division Multiplexer) and alternatives such as Packet-over-Sonet (PoS) have emerged, which are based on routers. A market segment has been created, wherein the Quality of Service exhibited by ATM (Asynchronous Transfer Mode) switches and the protection and restoration patterns of the telephone operators ceased to be used, in exchange for traffic without QoS, not protected and without a delivery guarantee, but with significantly lower costs.

The trend towards the use of systems with high rates, which associate IP over DWDM, is becoming intense, although, as indicated previously, without protection, restoration or QoS.

In fact, it can be noted that there is a scenario of competition between telephone operators and Internet providers, wherein the possibility of developing networks with the intelligence functions implemented on the physical optical layer can significantly alter the applications involving the current telecommunications networks.

In order to clarify what is meant by a physical layer, with the aim of creating connectivity standards for the interlinking of computational systems, the OSI model was created (Open System Interconnect).

General aspects of this connectivity were divided into seven functional layers in such a way as to try to facilitate the understanding of a communication process between the programs of a computer network. A brief summary follows describing what each layer is.

The physical layer covers the hardware specifications used in the network, which include mechanical, electrical and physical aspects. Another layer is that of enlace, which is restricted to only two network nodes. The protocols in this layer aim to make the data sent from one computer to another interconnected with it arrive in a correct form and without damage or loss. In the network layer, its protocols deal with routing the messages in the network according to routing algorithms, addressing and stream control disciplines. In a transport layer, the transport protocols have an “end to end” view of the communication process, guaranteeing that data sent from the origin will arrive at its destination, and for this it uses mechanisms such as stream control, error correction and others. A session layer deals with the “dialogue” between the programs that run in a network while the presentation layer deals with the syntax and semantics of these programs' data, e.g. the cryptography. The last layer is that of application, which deals strictly with the definition of the application protocols themselves.

U.S. Pat. No. 5,854,699 describes a data transport system, the addressing of which is made by an optical filter /λT, and subcarriers to supply the control information. This patent aims at dissociating traffic velocity from control signal velocity, as used in a LAN. There was a great concern with the high rates in control signal, because of silicon state of the art technology at the time this patent was filed. The control information is node identification, transmission channel identification, “free/busy” status, priority, acknowledgment, broadcast/unicast, and are extracted via information demodulation techniques transported by the subcarrier. Such a modulation is straight from the laser, and a single subcarrier is used to connect the control information common to all the nodes that use it by means of a token hierarchization.

Because of the modulation need in the subcarriers, it has a high response time, so that keying packet by packet is not possible in real time.

U.S. Pat. No. 5,847,852 describes an optical network, which has several subordinate optical networks that function as transmitters and receivers. The system used in this invention is an information transport system where frequency conversion occurs and addressing is WDM/SCM. Therefore, the signal check takes place by means of the conversion, and this procedure delays receiving the information via the node destination to which it is sent.

European patent No. 550,046 A2 describes a system for routing and switching of optical packets with multiplexed header and data. The procedure comprises the use of a multiplexed carrier to contain routing information. Such a header is transmitted on the same optical carrier, but at a lower velocity than that of the data packets. This makes the receivers process and detect such information by means of a lower cost receiver. It is possible to lessen the costs of the receiver, although what happens in the systems of the previously mentioned patents also takes place here. The information receiving time via the destination node still remains excessively long.

The great majority of current data transport systems transport data, which until it arrives at its destination, are open at each node along the path. This makes the information take a long time to arrive at its true destination.

### OBJECTS OF THE INVENTION

It is an object of this invention to reduce time spent in data addressing, protection and restoration.

It is an object of this invention to dispense with optical-electric and electric-optical conversions in the intermediate nodes during the transmission of the information held in a data packet.

It is another object of this invention to use intelligence functions of the physical layer without altering protocols.

It is still another object of this invention to expand the bandpass and use the intervals aimed at headers.

It is still another object of this invention to avoid opening and reading each packet to know its destination in a data transport system.

It is still another object of this invention to simplify the management of a data network—TMN (Telecommunications Management Network).

It is still another object of this invention to guarantee the data packet delivery, which is to be sent in a data transport system.

It is another object of this invention to allow the addressing and crosslinking directly on the optical layer.

It is another object of this invention to operate without altering the original frame signaling.

The objectives described above are achieved by means of a data transport system, which will be presented in further detail below.

### SUMMARY OF THE INVENTION

According to the description of this invention, a data transport system and method and its components are as follows:

The data transport system of this invention comprises:

A data packet emission device, which acts on the physical layer of a data transmission network, and has a device to attach information to data packets in the form of a tag. A device for reading the information on the data packet tag is also provided. The tag is external to said data packet, unmodulated and contains information indicating the address of origin and the destination of the data packet. The tag comprises at least one unmodulated RF subcarrier. The number of addresses referred to is 2n−1, n being the number of subcarriers. The system has an additional subcarrier to indicate the existence of a data packet to be transmitted.

The device for reading the information provided in the data packet tag detects the presence/absence of RF subcarriers and transforms them into a binary sequence. The data transmission is a telecommunications optical network. The data packet emission device comprises a Gigabit IP router, a microwave frequency generator, an RF logic switch, and a differential Mach-Zehnder modulator. The device for reading the information provided in the data packet tag comprises dielectric resonator filters, microwave detectors, a Gigabit detection switch and a Gigabit IP router.

The data transport process comprises: creating an information code like an external tag; attaching the information code like an external tag to a data packet; non-modulation of the tag which comprises the information code; sending the data packet with the tag to its destination; and decoding the tag information code during the data packet path, including to its destination, in a data transport network.

The tag information decoding of the data packet is effected by means of detecting the presence/absence of at least one unmodulated RF subcarrier. Then the information transposition for the information to a digital sequence indicating at least one destination address of the referred data packet takes place. The binary sequence identification is a function of a logic address. The attachment of the information code is accomplished in the manner of an external tag on a data packet. The data packet presence indication to be sent is attained by means of an RF subcarrier.

The information of the subcarrier constellation comprises destination/origin nodes indication (avoiding packet reading in intermediate nodes), the presence/absence of the packet in each network node, power levels—which are used for protection/restoration and simplification of the network TMN management.

The data transport system is passible for use in establishing an optical VPN (Virtual Private Network), which is selected and dedicated according to any telecommunications operator planning. In this data transport system, the subcarriers themselves carry information that will help in making decisions on protection and restoration and management agility in a telecommunications network.

### BRIEF DESCRIPTION OF THE DRAWINGS

For a better understanding of this invention, reference is made to the drawings/figures in which:

FIG. 1 shows a graphic in the frequency domain, a number of RF subcarriers are introduced above the payload spectrum;

FIG. 2 shows schematically how the RF subcarriers are electrically generated and next introduced in the optical spectrum;

FIG. 3 shows a complete schematic diagram of a node receiver, using subcarriers for protection and addressing;

FIG. 4 shows a block diagram of a generic optical network node when using electrical subcarriers for protection, restoration and addressing functions;

FIG. 5 shows a Microwave Carrier Generator, used in the system of FIG. 2;

FIG. 6 shows a Logical RF switch, used in the system of FIG. 2;

FIG. 7 shows an RF passive combiner, used in the system of FIG. 2;

FIG. 8 shows a dielectric-resonator (DR) filter, used in the system of FIG. 3: (a) dielectric-resonator, (b) dielectric-resonator physics implementation, and (c) graphic results of a dielectric-resonator-filter with different bands;

FIG. 9 shows a crystal quadratic RF detector, used in the system of FIG. 3;

FIG. 10 shows a gigabit detection switch, used in the system of FIG. 3: (a) implemented with NAND logical gates, and (b) implemented with AND and NAND logical gates;

FIG. 11 shows a block diagram of IP Gigabit Router.

### DETAILED DESCRIPTION

The explosive traffic growth due to the increase in Internet utilization is well known. The Optical WDM technology has became the preferred solution for coping with the exponential increase and demand for the utilization of ever greater bandwidths.

Optical WDM networks call for a very complex management array. Usually, there is a need to convert the optical data stream—in each network node—from the optical to the electric domain and also to open the data packets, in order to investigate whether or not the packets are aimed at the focused node. These operations are time-consuming (jeopardizing real-time voice and video transmissions) and also quite demanding with respect to equipment needs.

Any further step addressed to decreasing management array cost and/or decrease management processing time is worthwhile considering.

In this invention, restoration & protection, together with node routing, will be performed at the physical layer level. The mentioned protection may be also used for achieving protected IP transmissions—a procedure that it is not very usual. Rather, it is more a routine to convey IP—unprotected—over the so-called PoS (Packet over Sonet), where the Sonet protection bits have been removed.

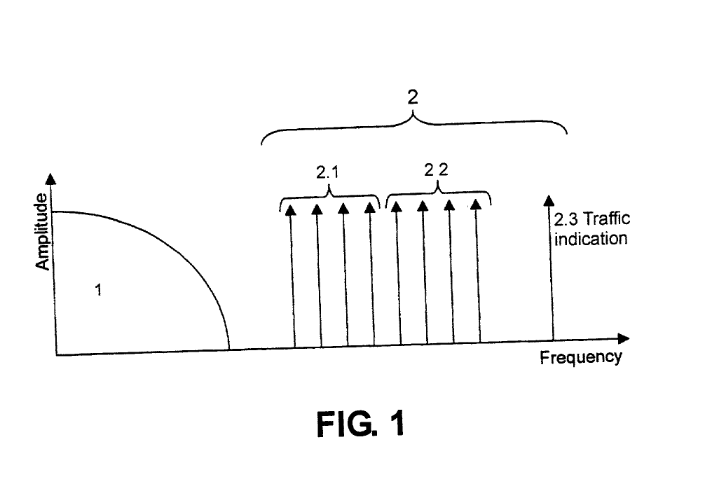

The above-mentioned restoration, protection and addressing operations will be performed by fast electronic circuitry in a very straightforward way or, in other words: notably fast when the software is used. In order to do so, when a node launches a data packet 1, a number of RF sub-carriers 2 are introduced above the payload frequency spectrum. The electrical spectrum will then look as depicted below, in FIG. 1.

In FIG. 1, a number of RF subcarriers 2 are introduced above the payload spectrum. Half of them identify the destination node 2.1, the other half identifies the source 2.2: an extra one 2.3 indicates that the circuit is on, to avoid misinterpretation of any link with a fault condition.

Next, while the packets 1 are received at the correct node, suitable optoelectronic circuitry will process these subcarriers 2 in order to offer protection & restoration, together with routing operations.

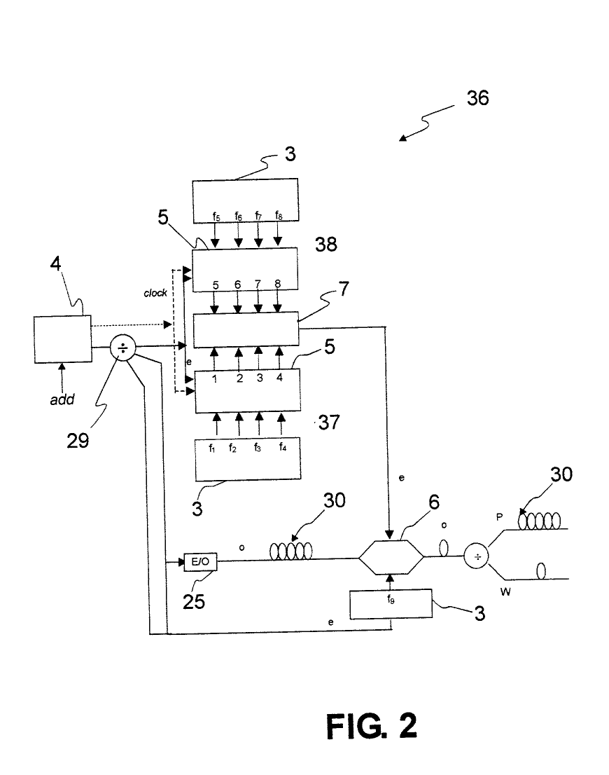

FIG. 2 shows a transmitter device 36 comprising an IP Router 4 associated with an RF sub-system. At the transmitter, the Microwave Carrier Generator 3 electrically generates nine RF/microwave subcarriers; one of them (f9) will be introduced whenever a node emits a data packet. The subcarriers, f1, f2, f3 and f4 generated through the Source Generator 37 identify the source node, while the others four f5, f6, f7 and f8 generated through the Destination Generator 38 identify the destination node.

A logical RF Switch 5 uses data from IP Router 4 to compose a subset of the subcarrier related with the destination node 2.1 and another Logical RF Switch 5 will compose a subset of the subcarrier related with the emitting (origin) node 2.2, in the same manner. The generated subcarriers will be combined through the RF Passive Combiner 7 and next introduced in the optical spectrum by means of a differential Mach-Zehnder (MZI) 6. The extra subcarrier (f9), which controls the data packet existence, is introduced in the optical spectrum through the same Mach-Zehnder (MZI) differential 6.

The number of subcarriers and their respective frequency allocation is to be settled by the network designer. For doing so, the strategic approach is the following:

(a) A subset comprising half of the subcarrier set is related with the emitting (origin) node;

(b) The other half of the subcarrier set is related with the receiving (destination) node;

(c) The specific subcarrier frequency positions are such that each subcarrier subset describes—unequivocally—a unique emitting node and a unique receiving node;

(d) Furthermore, there is an extra subcarrier 2.3, which indicates that the connection is “on”. Without this carrier, an idle traffic condition could be misinterpreted as a fault, as will be seen below.

The total number of nodes is 2N−1, where N is the number of subcarriers used to form the addressing code. In principle, the subcarriers remain unmodulated. If they were modulated, their number might be substantially reduced. However, their action would only be effective after demodulating the information they carry. This latter operation is much slower than a simple detection of their presence. Consequently, if network management speed is the prime objective, CW (continuous wave) subcarriers are preferred.

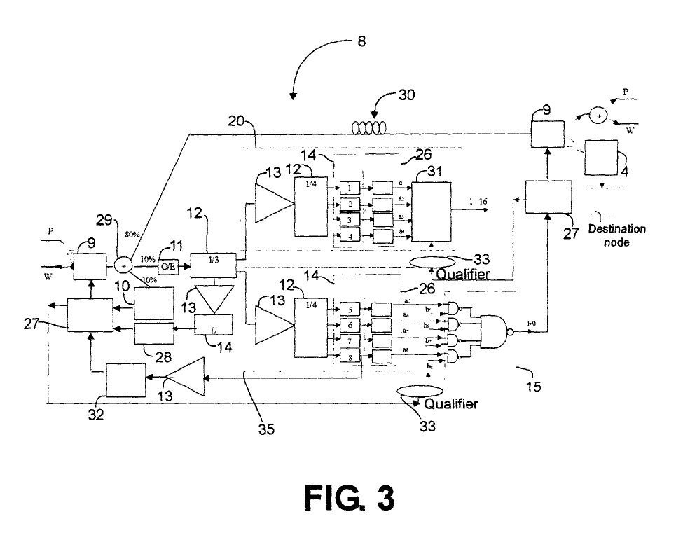

According to FIG. 3, the protection and restoration action using the subcarriers is performed according to the following steps:

(a) For any receiving node there is a particular subcarrier subset combination related with the referred node address (called “bits b”);

(b) A sample of the subcarrier subset related to destination node function is detected, filtered and sent to logical gates 15; The first two actions are performed by the destination detector 26 and filter 14, respectively;

(c) If a positive logical sign is obtained at the Gigabit Detection Switch 15 output, it means that the arriving data packet is designated to this node. Packet processing procedures are then activated;

(d) If the above-mentioned positive sign is absent, either the data packet is not aiming at the referred node, or the link is faulty;

(e) To solve the above question, there is an additional mechanism, traffic detector 28, to detect if either the traffic indicator subcarrier 2.3 is absent (failure situation), or if it is present and/or still, at least one subcarrier is present (non-failure situation, momentarily with no traffic, or data seeking a different node, respectively).

When a failure situation, as described above, occurs, there will be a commutation, at the first Optical Switch 9, from the working (W) optical channel to that of protection (P).

Previously, it was mentioned that—in each node—the subcarrier subset that is related to the node destination function 2.1 is detected locally and electrically processed.

This processing comprises the use of narrowband filters 14: each one tuned to one of the subcarrier frequencies.

FIG. 3 shows a complete schematic diagram of the receiver circuitry 8 in each node, which is able to supervise the RF subcarriers 2. The optical signal is divided into three parcels by a splitter 29. The first one, (80%), follows transporting through an optical delay 30. The second (10%) is used by the system to verify the optical signal level received through a power level monitor 10. The third is converted to the electrical domain by a photodetector 11.

Subsequently, signal splitters 12 and RF amplifiers 13 will route the above-mentioned signal to a narrowband filter array 14. In FIG. 3, this array is illustrated by an 8-dielectric-resonator-filter array. The array is composed of two sub-arrays: The first sub-array 14 comprises filters 1, 2, 3 and 4, which deals with the subcarriers related with the origin node. The second sub-array 14 (filters 5, 6, 7 and 8) deals with the subcarriers related with the destination node. After detection 26, each sub-array is able to furnish binary codes describing the origin and destination nodes, respectively. The origin binary code is later converted by the decode unit 31, while the destination binary code is being analyzed by the Gigabit Detection Switch 15 and compared with the particular bits “b” sequence (b5 b6 b7 b8) implemented in each node.

Additionally, the traffic indicator subcarrier f9 (which is always on) is filtered 14 and detected 28 by the receiving node. This furnishes an indication of transmission of data packet 1, even during an idle traffic condition. In this way, there will always exist the possibility of power monitoring. This latter operation is necessary for choosing between receiving either W (Working) fiber channel or P (Protection) fiber channel. After the W or P channels decision, there is binary code analysis related with the destination node. In order to do so, component 33 enables the identification bits “b”.

In case the destination node is the one that is being focused, a second decision circuit 27 will connect the second optical switch 9 to the pertinent node router 4 (Drop Switch Router) in FIG. 3.

Meanwhile, the RF subcarriers 2 will be “on” during a whole SONET frame, if this is the case. Observe the optical delay element 30, providing correct timing with respect to the decision circuits 34 and the second optical switch 9.

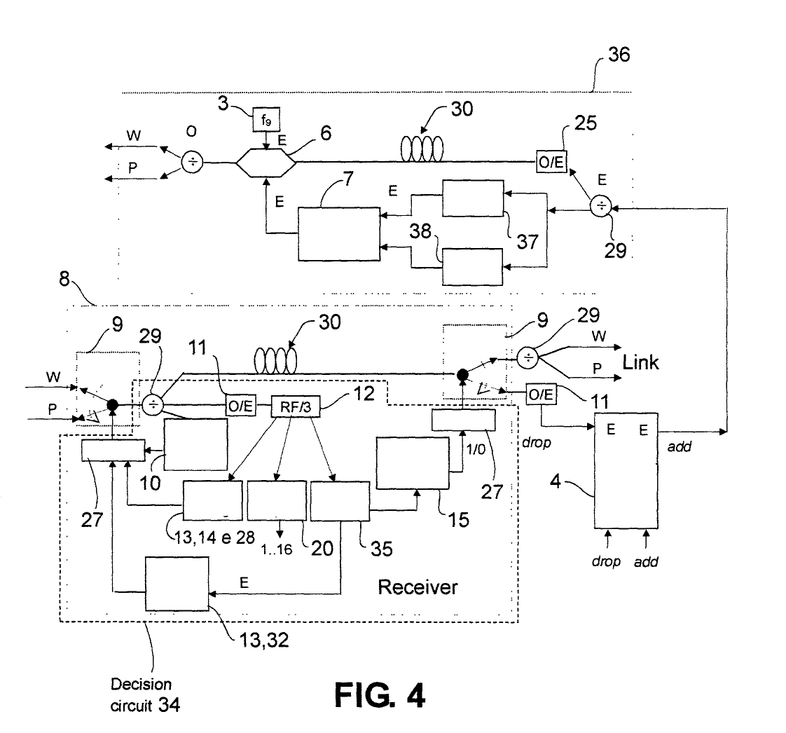

Concerning the concatenated action of the transmitter, together with the receiver, FIG. 4 is furnishing a block diagram of a complete generic node. There, using a schematic diagram becomes clear what has been previously described in FIG. 2 and FIG. 3.

Microwave Carrier Generator 3

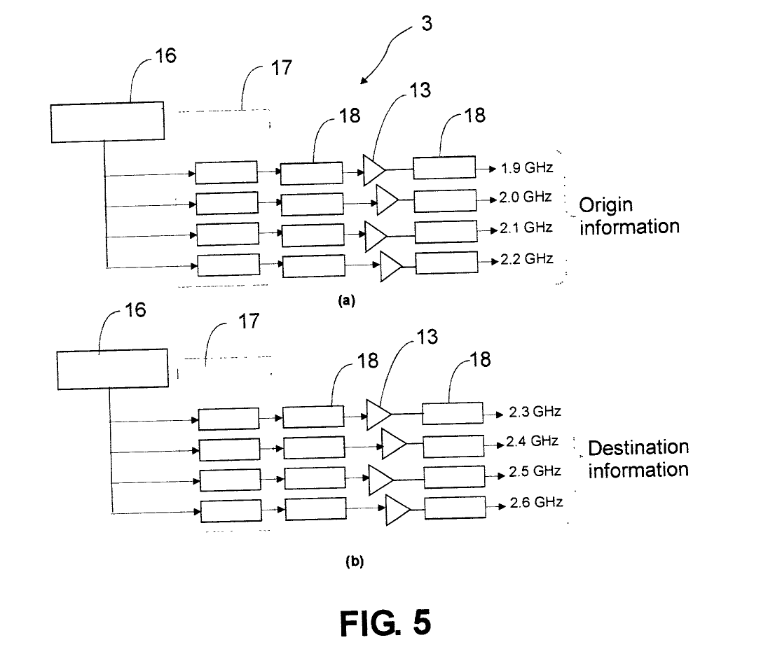

The main function of the Microwave Carrier Generator 3, described in FIG. 2, is to generate the RF subcarriers 2. With reference to FIG. 5, which shows a detailed Microwave Carrier Generator, a Crystal Oscillator 16 in 100 MHz, combined with frequency multipliers 17, narrow-band filters 18 and amplifiers 13, generates eight different frequencies. These eight frequencies are separated from each other by 100 MHz, and will be used to form the addressing code. The subcarriers, 1.9, 2.0, 2.1 and 2.2 GHz identify the source node addressing, while the other four 2.3, 2.4, 2.5 and 2.6 identify the destination node address. It is worth mentioning that these numbers are just an example and other frequency ranges can also be used.

Logical RF Switch 5

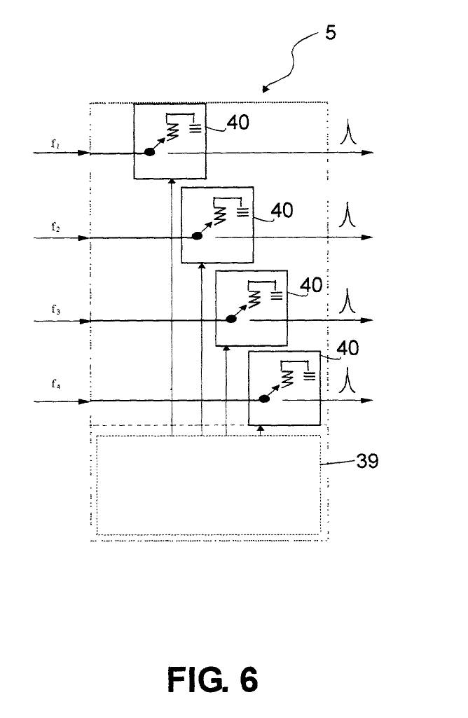

The Logical RF Switch 5, detailed in FIG. 6, is responsible for combining the RF subcarriers in order to form the addressing codes 2.1 and 2.2. Each network node has a fixed address, which is represented by a binary code. The “on/off” RF subcarriers 2, indicating bits “1/0”, respectively, represent this code.

To generate the right combination, a logical intelligence 39 is used. This intelligence will command the RF switches 40 enabling or not the subcarrier 2 transmission and then forming an addressing code.

RF Passive Combiner 7

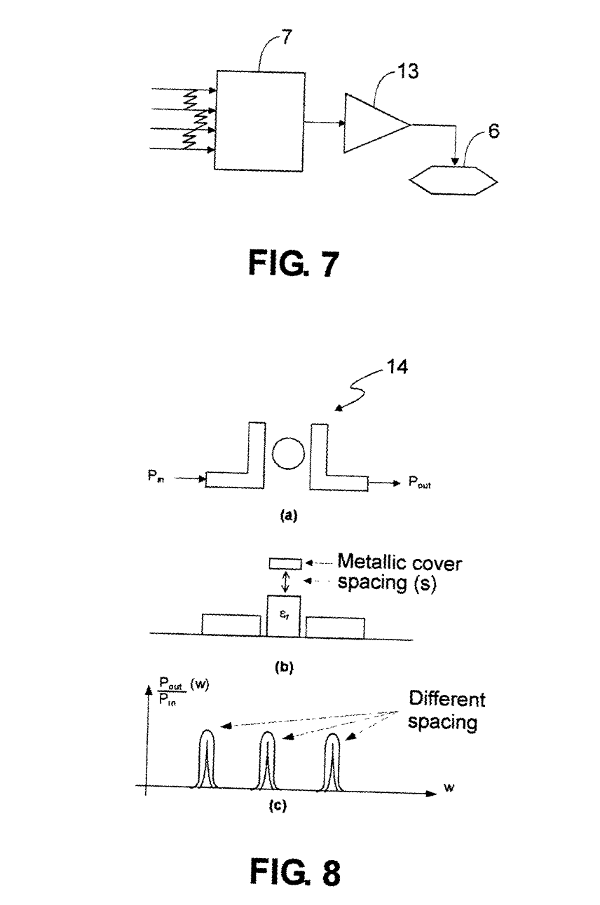

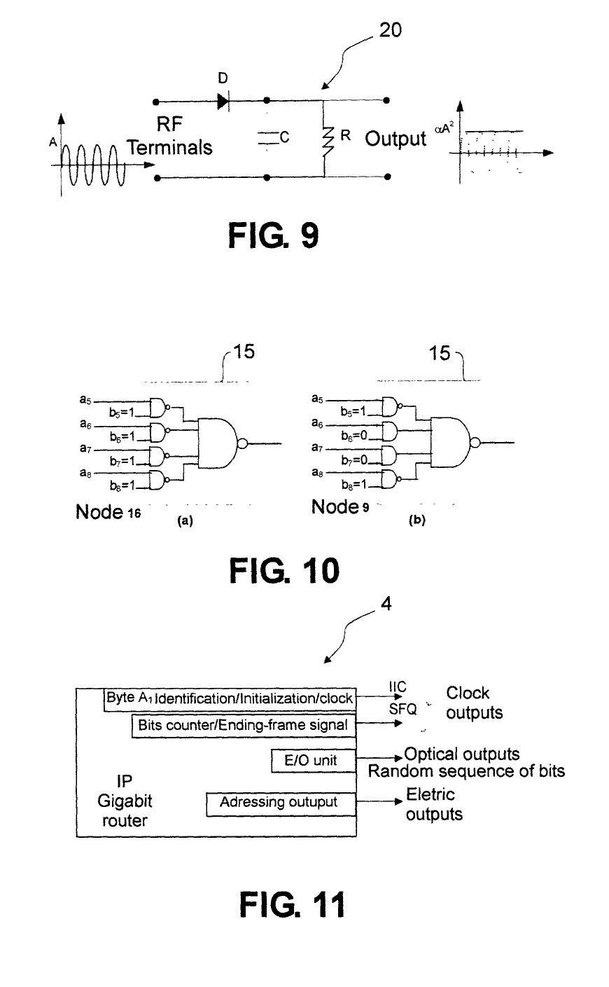

The previously generated subcarriers 2 form a code that indicates the addressing of origin node 2.2 that launch the data and the addressing of the destination node 2.1 at which this data is aimed. An RF Passive Combiner 7, shown in FIG. 7, combines the four origin subcarriers and the four destination subcarriers, to later be amplified 13 and then added to the optical spectrum by means of a Mach-Zehnder device 6.

Dielectric-Resonator (DR) Filter 14

As in applied case subcarriers 2 are spaced from each other just in 5%, and since this distance is too small for the micro-strip or strip-line filters to be used, dielectric resonator filters (DR Filters) 14 were chosen. Dielectric cavities with very high εr values (for instance: εr=40, εr=80, . . . ) have been used in coupled lines structures, in association with the possible tuning of the cavity TE01δ mode, according to FIG. 8.

Accordingly, filters in microwave frequencies with low insertion loss (<1 dB) e narrow tuning—due to a very high Qloaded value presented in resonators—can easily be constructed and at low cost. Tuning is made by metallic or dielectric screws, which descend on to the resonator.

Detectors 20

The detectors 20 will transform the RF subcarriers 2 into a binary number that indicates an addressing code. The presence or not of these subcarriers 2 corresponds to bits “1” or “0”, respectively.

The crystal microwave detector 20 works like an RF signal rectifier, taking the amplitude of the microwave signal off. This type of configuration can be dimensioned for rising time less than 10 picoseconds and it can be interfaced with Emitter Coupled Logic—ECL or Source Coupled FET Logic—SCFL.

Gigabit Detection Switch 15

The main function of this block is to compare the binary code received—through bits “a”, with the local addressing binary code (bits “b”), in order to check if the node is intended to be the destination of the transmitted data packet 1.

The Gigabit Detection Switch 15 is implemented using ultra-fast logical gates like AND or NAND, depending on the local node addressing code (bits “b”). FIG. 10 shows examples of this implementation.

In conclusion, based on these examples, AND gates are used when bit “b=0”, otherwise NAND gates will be used (“b=1”). It takes place like this in order to always take logical value results as “1” when the bit sequence “a5 a6 a7 a8” is equivalent to bits “b5 b6 b7 b8” or logical value results as “0” when these bits do not match. The examples show that when the binary code received (bits “a”) does not match with the local addressing code (bits “b”), it will generate a logical value “0” as a result, indicating that the data packet 1 is not aimed at this specific node. But if the codes match (bits “a”=bits “b”) the Switch 15 will indicate the logical value “1”, indicating that this specific node corresponds to the destination of the data packet 1.

IP Gigabit Router 4

This block can be considered as an additional unit, which selects and implements functions in order to synchronize the system proposed in this invention. This unit has at least four outgoing signals that will be applied at the transmission module. The two first indicate the start and stop clock time, respectively, and the third is the optical output corresponding to the data packet 1, while the fourth provides the addressing codes.

The byte A1 initializes the system clock and, after approximately 20 μs, the information of origin and destination addressing have already been received by the Microwave Frequency Generator 3.

From this moment, the RF subcarriers 2 could be activated at up to 100 μs, coinciding with the payload transmission, transposed to the optic domain. In this way, each combination of destination and origin address will have a lifetime similar to its associated Frame.

Therefore, it must be understood that the system and its described component parts above are only some of the modalities and examples of situations that could occur, while the real target of the object of the invention will be defined in the claims.

1. Data transport system comprising:
an emission device (36) of a data packet (1);
said data packet emission device (36) having a device to attach information (6) in said data packet (1) like a tag (2);
a device for reading (8) the information provided in the tag (2) of the data packet (1);
said system characterized in that said tag (2) is external to said data packet (1), unmodulated, and contains information indicating at least the data packet destination address.

2. System according to claim 1, characterized in that the tag comprises at least one unmodulated RF subcarrier (2).

3. System according to claim 1, characterized in that tag (2) further has information indicating the origin address of the data packet (1).

4. System according to claim 2, characterized in that tag (2) further has information indicating the origin address of the data packet (1).

5. System according to claim 1, characterized in that the number of received addresses is 2n−1, n being the number of subcarriers.

6. System according to claim 2, characterized in that the number of received addresses is 2n−1, n being the number of subcarriers.

7. System according to claim 3, characterized in that the number of received addresses is 2n−1, n being the number of subcarriers.

8. System according to claim 4, characterized in that the number of received addresses is 2n−1, n being the number of subcarriers.

9. System according to claim 1, characterized in that information contained in said tag (2) indicates, preferentially, the origin and destination of data packet (1).

10. System according to claim 2, characterized in that information contained in said tag (2) indicates, preferentially, the origin and destination of data packet (1).

11. System according to claim 2, characterized in that it has an additional subcarrier (2.3) to indicate the existence of a data packet to be transmitted.

12. System according to claim 1, characterized in that reading device (8) of the information provided in tag (2) of data packet (1) detects the presence/absence of RF subcarriers and transforms them into a binary sequence.

13. System according to claim 2, characterized in that reading device (8) of the information provided in tag (2) of data packet (1) detects the presence/absence of RF subcarriers and transforms them into a binary sequence.

14. System according to claim 1, characterized in that data packet emission device (36) acts on the physical layer of a data transmission layer.

15. System according to claim 14, characterized in that data the transmission network is a telecommunications optical network.

16. System according to claim 1, characterized in that the data packet emission device comprises an IP router (4), a microwave frequency generator (3), an RF logic switch (5), an RF passive combiner (7) and a differential Mach-Zehnder modulator (6).

17. System according to claim 1, characterized in that the reading device for information provided in the data packet tag comprises basically dielectric resonator filters (14), microwave detectors (20), Gigabit detector switches (15) and a Gigabit IP router (4).

18. Data transport process, comprising the following steps:
creating an information code like an external tag;
attaching the information code like an external tag to a data packet;
said process characterized in that it comprises non-modulation of the tag, which comprises the information code;
sending the data packet with the tag to its destination; and
decoding the tag information code during the data packet path, including to its destination, in a data transport network.

19. Process according to claim 18, characterized in that it further comprises decoding the information of data packet tag by means of the detection of the presence/absence of at least one unmodulated RF subcarrier.

20. Process according to claim 19, characterized in that it further comprises transposition of the information for a digital sequence indication of at least one destination address of said data packet.

21. Process according to claim 20, characterized in that it comprises a binary sequence identification related to a logical address.

22. Process according to claim 18, characterized in that attachment of the information code like an external tag in a data packet takes place in an optical domain.

23. Process according to claim 18, characterized in that it comprises an indication of the presence of a data packet to be sent by means of an RF subcarrier.
